(19) United States
(12) Patent Application Publication
(10) Pub. No.: US 2026/0044027 A1
(43) Pub. Date: Feb. 12, 2026

(54) STRUCTURES FOR A THERMO-OPTIC PHASE SHIFTER

(71) Applicant: GlobalFoundries U.S. Inc., Malta, NY (US)

(72) Inventors: Aneesh Dash, Bangalore (IN); Kevin K. Dezfulian, Arlington, VA (US)

(21) Appl. No.: 18/795,395

(22) Filed: Aug. 6, 2024

(51) Int. Cl. G02F 1/01

(52) U.S. Cl. CPC G02F 1/0147

(57) ABSTRACT

Structures for a thermo-optic phase shifter and methods of forming such structures. The structure comprises a waveguide core, and a heater that includes a heating element, a first extension that projects from the first heating element, and a second extension that projects from the heating element. The heating element overlaps with a portion of the waveguide core, and the portion of the waveguide core is positioned laterally between the first extension and the second extension.

### BACKGROUND

The disclosure relates to photonic chips and, more specifically, to structures for a thermo-optic phase shifter and methods of forming such structures.

Photonic chips are used in many applications and systems including, but not limited to, data communication systems and data computation systems. A photonic chip includes a photonic integrated circuit comprised of photonic components, such as modulators, polarizers, and couplers, that are used to manipulate light received from a light source, such as an optical fiber or a laser.

A phase shifter is a photonic component that can be used on a photonic chip to modulate the phase of light propagating in a waveguide core. One type of phase shifter may operate by a thermo-optic mechanism in which heat is transferred to the waveguide core, which is comprised of a material having a refractive index that varies with temperature. Another type of phase shifter may operate by an electro-optic mechanism by biasing a p-n junction inside the waveguide core. Conventional phase-shifters are limited by the ability to tolerate high optical powers.

Improved structures for a thermo-optic phase shifter and methods of forming such structures are needed.

### SUMMARY

In an embodiment of the invention, a structure for a thermo-optic phase shifter is provided. The structure comprises a waveguide core, and a heater that includes a heating element, a first extension that projects from the first heating element, and a second extension that projects from the heating element. The heating element overlaps with a portion of the waveguide core, and the portion of the waveguide core is positioned laterally between the first extension and the second extension.

In an embodiment of the invention, method of forming a structure for a thermo-optic phase shifter is provided. The method comprises forming a waveguide core, and forming a heater that includes a heating element, a first extension that projects from the first heating element, and a second extension that projects from the first heating element. The heating element overlaps with a portion of the waveguide core, and the portion of the waveguide core is positioned laterally between the first extension and the second extension.

### BRIEF DESCRIPTION OF THE DRAWINGS

The accompanying drawings, which are incorporated in and constitute a part of this specification, illustrate various embodiments of the invention and, together with a general description of the invention given above and the detailed description of the embodiments given below, serve to explain the embodiments of the invention. In the drawings, like reference numerals refer to like features in the various views.

FIG. 1 is a top view of a structure at an initial fabrication stage of a processing method in accordance with embodiments of the invention.

FIG. 1A is a cross-sectional view taken generally along line 1A-1A in FIG. 1.

FIG. 2 is a top view of the structure at a fabrication stage of the processing method subsequent to FIGS. 1, 1A.

FIG. 2A is a cross-sectional view taken generally along line 2A-2A in FIG. 2.

FIG. 3 is a cross-sectional view of the structure at a fabrication stage of the processing method subsequent to FIGS. 2, 2A.

FIG. 4 is a cross-sectional view of a structure in accordance with alternative embodiments of the invention.

FIG. 5 is a cross-sectional view of a structure in accordance with alternative embodiments of the invention.

FIG. 6 is a cross-sectional view of a structure in accordance with alternative embodiments of the invention.

FIG. 7 is a cross-sectional view of a structure in accordance with alternative embodiments of the invention.

FIG. 8 is a top view of a structure in accordance with alternative embodiments of the invention.

FIG. 9 is a top view of a structure in accordance with alternative embodiments of the invention.

### DETAILED DESCRIPTION

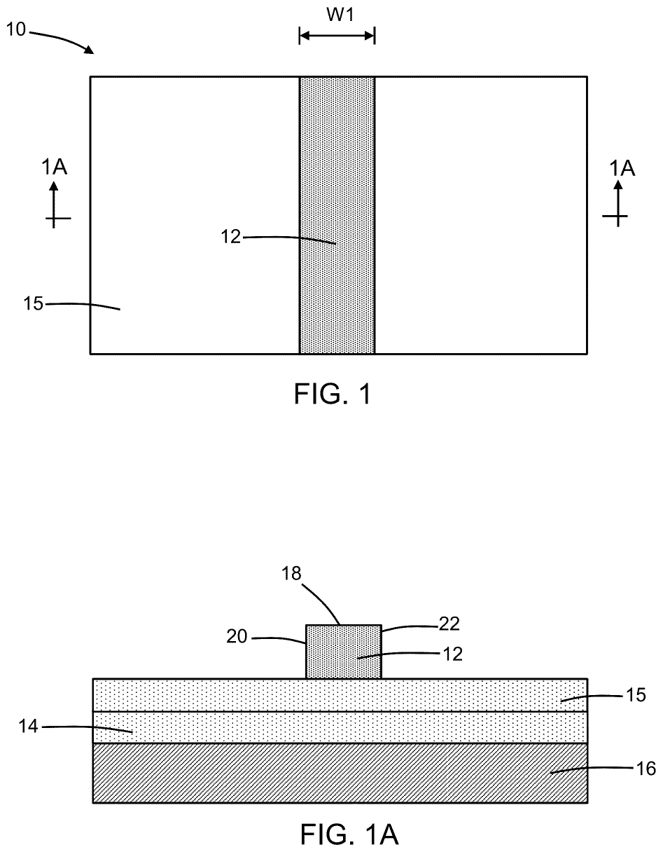

With reference to FIGS. 1, 1A and in accordance with embodiments of the invention, a structure 10 for a thermo-optic phase shifter includes a waveguide core 12 that is disposed on, and over, dielectric layers 14, 15 and a semiconductor substrate 16 of a photonics chip. In an embodiment, the dielectric layers 14, 15 may be comprised of a dielectric material, such as silicon dioxide, and the semiconductor substrate 16 may be comprised of a semiconductor material, such as single-crystal silicon. In an embodiment, the dielectric layer 14 may be a buried oxide layer of a silicon-on-insulator substrate. In an alternative embodiment, the dielectric layer 15 may be omitted from the structure 10.

The waveguide core 12 includes an upper surface 18, a lower surface that adjoins the dielectric layer 15 and that is opposite from the upper surface 18, and opposite side surfaces 20, 22. The upper surface 18 is positioned between, and connects, the side surface 20 and the side surface 22. The waveguide core 12 has a width W1 between the side surface 20 and the side surface 22 that may be equal to the width of the upper surface 18.

In an embodiment, the waveguide core 12 may be comprised of a material having a refractive index that is greater than the refractive index of silicon dioxide. In an embodiment, the waveguide core 12 may be comprised of a dielectric material, such as silicon nitride, silicon oxynitride, or aluminum nitride. In an alternative embodiment, the waveguide core 12 may be comprised of a semiconductor material, such as silicon or germanium. In alternative embodiments, other materials, such as a polymer, diamond, thin-film lithium niobate, boron nitride, barium titanate, or a III-V compound semiconductor, may be used to form the waveguide core 12.

In an embodiment, the waveguide core 12 may be formed by depositing a layer comprised of its constituent material and patterning the deposited layer with lithography and etching processes. In an alternative embodiment, a thin slab layer may be connected to a lower portion of the waveguide core 12 to provide a rib waveguide. In an alternative embodiment, the waveguide core 12 may be configured as a slotted waveguide.

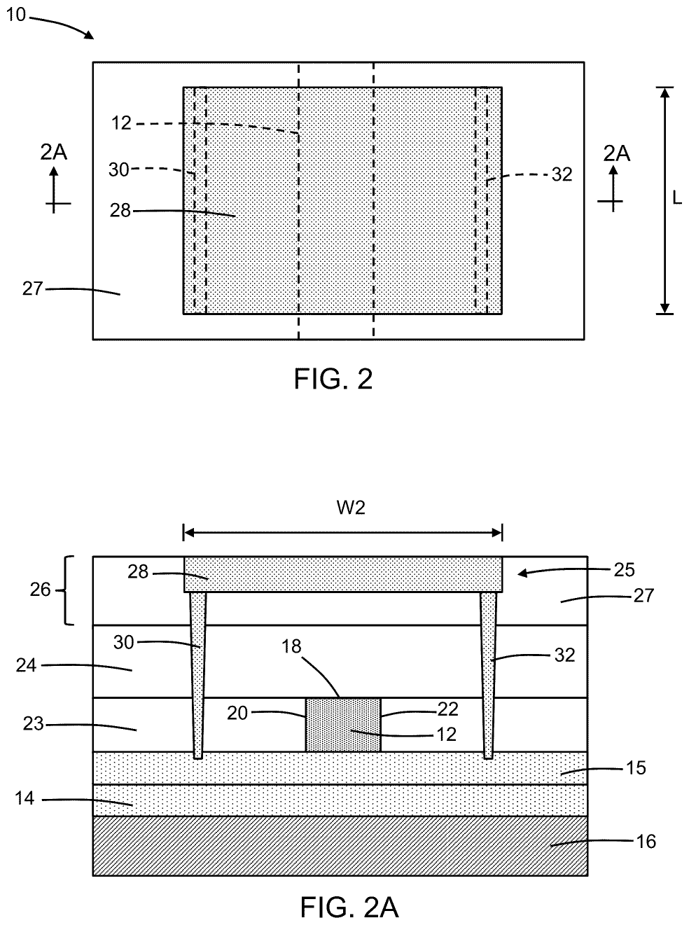

With reference to FIGS. 2, 2A in which like reference numerals refer to like features in FIGS. 1, 1A and at a subsequent fabrication stage, dielectric layers 23, 24 are formed on, and over, the waveguide core 12. The dielectric layers 23, 24 may be comprised of a dielectric material, such as silicon dioxide, having a refractive index that is less than the refractive index of the material constituting the waveguide core 12.

One or more dielectric layers of a back-end-of-line stack 26 may be formed over the dielectric layers 23, 24. The one or more dielectric layers of back-end-of-line stack 26 may each be comprised of a dielectric material, such as silicon dioxide, silicon nitride, tetraethylorthosilicate silicon dioxide, or fluorinated-tetraethylorthosilicate silicon dioxide.

The back-end-of-line stack 26 may include a dielectric layer 27 and a heater 25 that includes a heating element 28 formed in the dielectric layer 27 and extensions 30, 32 that project from the heating element 28 in a vertical direction toward the semiconductor substrate 16. The heating element 28 is positioned adjacent to, and over, the upper surface 18 of the waveguide core 12. In an embodiment, the heating element 28 may be a planar strip that extends parallel to the upper surface 18 of the waveguide core 12, which may also be planar. The planar strip embodied by the heating element 28 may be characterized by a length L, a width W2, and a thickness. The heating element 28, which is vertically offset from the upper surface 18 of the waveguide core 12, has an overlapping relationship with the waveguide core 12. In an embodiment, the heating element 28 may fully overlap with the waveguide core 12. The width W2 of the heating element 28 is greater than the width W1 of the waveguide core 12. In an embodiment, the waveguide core 12 may be centered beneath the heating element 28 and between the extensions 30, 32.

The extensions 30, 32 effectively increase the spatial extent of the heater 25. In an embodiment, the extension 30 may include a bar via that is positioned adjacent to the side surface 20 of a portion of the waveguide core 12, and the extension 32 may include a bar via that is positioned adjacent to the side surface 22 of the portion of the waveguide core 12. The heating element 28 and the extensions 30, 32 may surround the adjacent portion of the waveguide core 12 on multiple sides. In an embodiment, bar vias embodied in the extensions 30, 32 may be oriented with lengthwise alignment parallel to the adjacent portion of the waveguide core 12. The side surface 20 of the waveguide core 12 is positioned laterally between the side surface 22 and the extension 30, and the side surface 22 of the waveguide core 12 is positioned laterally between the side surface 20 and the extension 32.

In an embodiment, the heating element 28 and the extensions 30, 32 may be comprised of a conductor. In an embodiment, the heating element 28 and the extensions 30, 32 may be comprised of a metal, such as copper. In an embodiment, the heating element 28 and the extensions 30, 32 may be comprised of a doped semiconductor, such as doped polysilicon. In an embodiment, the heating element 28 may be formed in the dielectric layer 27 of the back-end-of-line stack 26 by a damascene process. In an embodiment, the extensions 30, 32 may be formed by etching trenches with lithography and etching processes and depositing the conductor to fill the etched trenches.

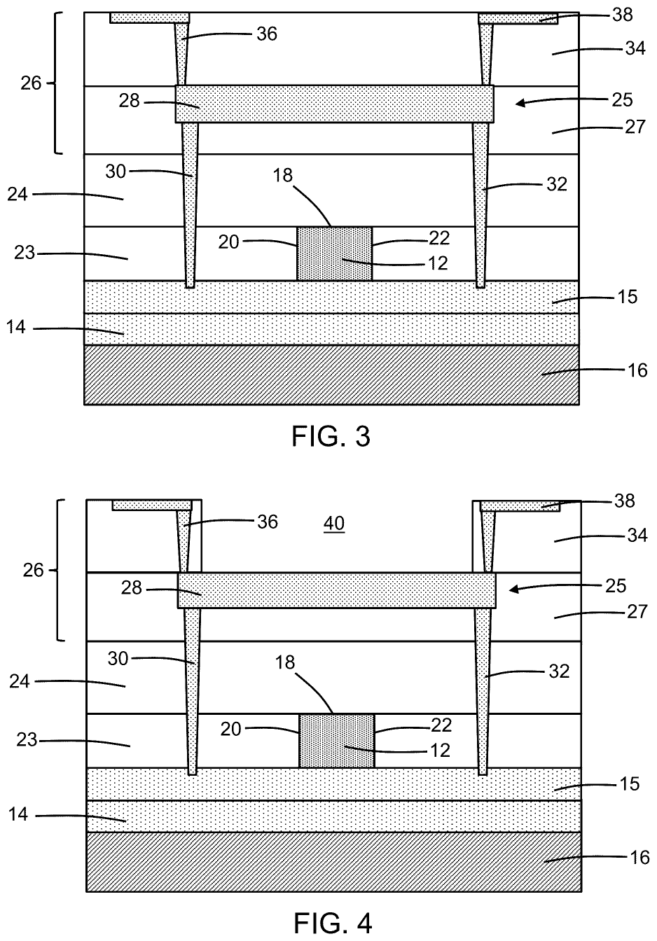

With reference to FIG. 3 which like reference numerals refer to like features in FIGS. 2, 2A and at a subsequent fabrication stage, one or more dielectric layers 34 of the back-end-of-line stack 26 may be formed over the dielectric layer 27 and the heating element 28 of the heater 25. Each of the one or more dielectric layers 34 may be comprised of a dielectric material, such as silicon dioxide or silicon nitride.

Metal features 36 are formed as wiring in the one or more dielectric layers 34. The metal features 36 are physically and electrically connected by vias 38 to the heating element 28 of the heater 25. The metal features 36 and vias 38 may be comprised of a metal, such as copper or aluminum. The metal features 36 may be used to connect the heating element 28 to a power source, which can be operated to supply a current that causes Joule heating of the heating element 28. The extensions 30, 32 conduct heat from the heating element 28 such that heat is transferred by the heating element 28 and the extensions 30, 32 in multiple directions to the adjacent portion of the waveguide core 12.

In use, the waveguide core 12 confines propagating light such that the highest optical intensity region of the optical mode is associated within and immediately adjacent to the waveguide core 12. Heat generated by the heating element 28 is transferred from the heating element 28 and the extensions 30, 32 to the adjacent portion of the waveguide core 12. The temperature of the adjacent portion of the waveguide core 12 is elevated by the transferred heat, which is effective to change the refractive index of the heated portion of the waveguide core 12 and thereby change the phase of the propagating light.

In an alternative embodiment, the heater 25 may be deployed in an arm of a Mach-Zehnder modulator to provide phase shifting. In an alternative embodiment, the heater 25 may be deployed in a ring resonator. In an alternative embodiment, the waveguide core 12 may include one or more bends that permit the waveguide core 12 to make multiple passes beneath the heating element 28.

The heater 25 may enable thermal tuning of light propagating in the waveguide core 12. Constructing the waveguide core 12 from a dielectric material, such as silicon nitride, may provide a power handling capability that is greater than the power handling capability of other materials, such as silicon, and may particularly benefit from the utilization of the heater 25 for introducing a phase shift.

With reference to FIG. 4 in which like reference numerals refer to like features in FIG. 3 and in accordance with alternative embodiments, a recess 40 may be patterned in the back-end-of-line stack 26 to remove dielectric material from a location above the heating element 28 of the heater 25. Specifically, the recess 40 may be formed in the one or more dielectric layers 34 of the back-end-of-line stack 26. In an embodiment, the recess 40 may extend fully through the dielectric layers 34 to the heating element 28. The heating element 28 is positioned in a vertical direction between the waveguide core 12 and the recess 40. The removed dielectric material reduces the thermal mass of dielectric material that is adjacent to the heating element 28.

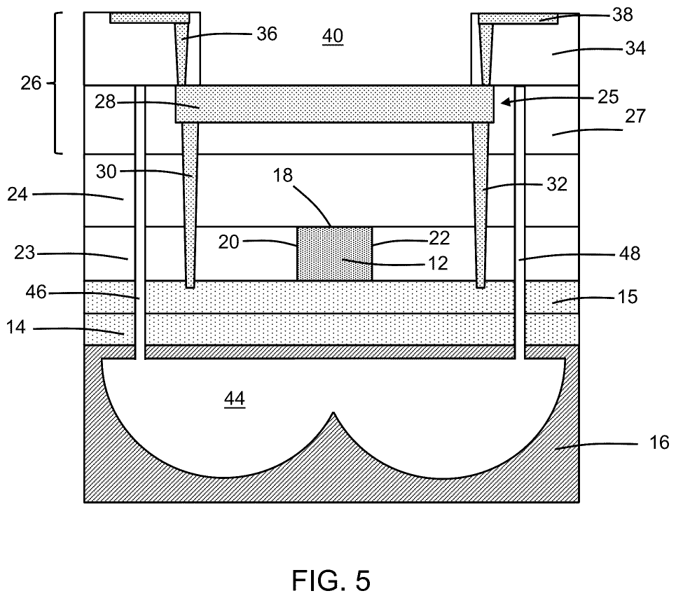

With reference to FIG. 5 in which like reference numerals refer to like features in FIG. 4 and in accordance with alternative embodiments, the structure 10 may further include a cavity 44 in the semiconductor substrate 16. The cavity 44 may be formed by an isotropic etching process that includes a vertical etching component and a lateral etching component. The cavity 44 may provide thermal isolation of the heater 25 from the bulk of the semiconductor substrate 16. In an embodiment, the cavity 44 may be filled by air or a different gas. In an alternative embodiment, the cavity 44 may be filled by a dielectric material that is a thermal insulator. In the representative embodiment, the cavity 44 may include a pair of interconnected chambers. In an alternative embodiment, the cavity 44 may include more than a pair of interconnected chambers. The cavity 44 may improve the thermal isolation of the heater 25.

The structure 10 may further include trenches 46, 48 that extend through the dielectric layer 27 of the back-end-of-line stack 26, the dielectric layers 23, 24, and the dielectric layers 14, 15. The waveguide core 12 is laterally positioned between the trench 46 and the trench 48. In an embodiment, the waveguide core 12 may be centered laterally between the trench 46 and the trench 48. The extension 30 is laterally positioned between the waveguide core 12 and the trench 46, and the extension 32 is laterally positioned between the waveguide core 12 and the trench 48.

In an embodiment, the trenches 46, 48 may be filled by air or a different gas. In an alternative embodiment, the trenches 46, 48 may be filled by a dielectric material that is a thermal insulator. In an alternative embodiment, the trenches 46, 48 may extend through dielectric layers 14, 15 to the cavity 44. In an alternative embodiment, the trenches 46, 48 may terminate within one or the other of the dielectric layers 14, 15 without penetrating into the cavity 44. The trenches 46, 48 may improve the thermal isolation of the heater 25.

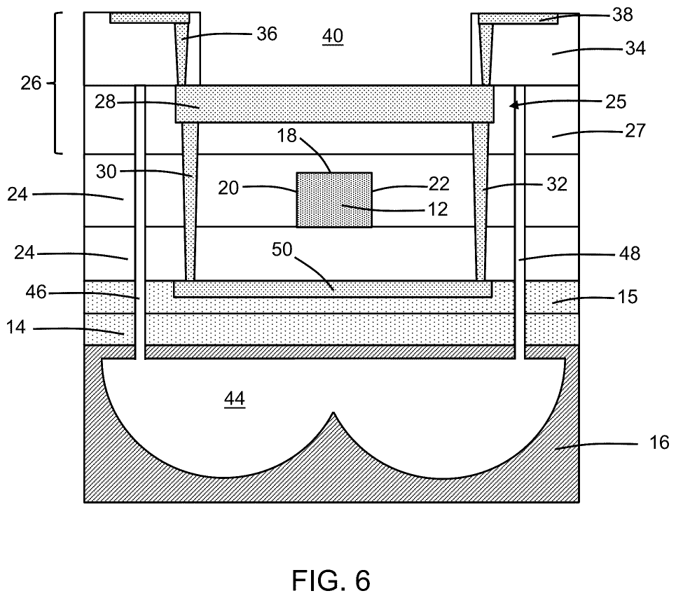

With reference to FIG. 6 in which like reference numerals refer to like features in FIG. 5 and in accordance with alternative embodiments, the heater 25 may include another heating element 50 that is positioned below the waveguide core 12. An adjacent portion of the waveguide core 12 is positioned in a vertical direction between the heating element 28 and the heating element 50, as well as being positioned laterally between the extensions 30, 32. The extensions 30, 32 may physically and electrically connect the heating element 28 to the heating element 50. In an embodiment, the heating element 28, the heating element 50, and the extensions 30, 32 may fully surround the adjacent portion of the waveguide core 12 on all sides. In an embodiment, the heating element 28 may be planar strip that extends parallel to the upper surface 18 of the waveguide core 12, and the heating element 50 may be planar strip that extends parallel to the lower surface of the waveguide core 12.

In an alternative embodiment, the additional heating element 50 of the heater 25 may be formed in the back-end-of-line stack 26 over the heating element 28 such that the heater 25 includes multiple heating elements that are positioned over the waveguide core 12. In an alternative embodiment, an additional trench may be formed adjacent to the trench 46 and an additional trench may be formed adjacent to the trench 48 in order to increase the thermal isolation of the heater 25.

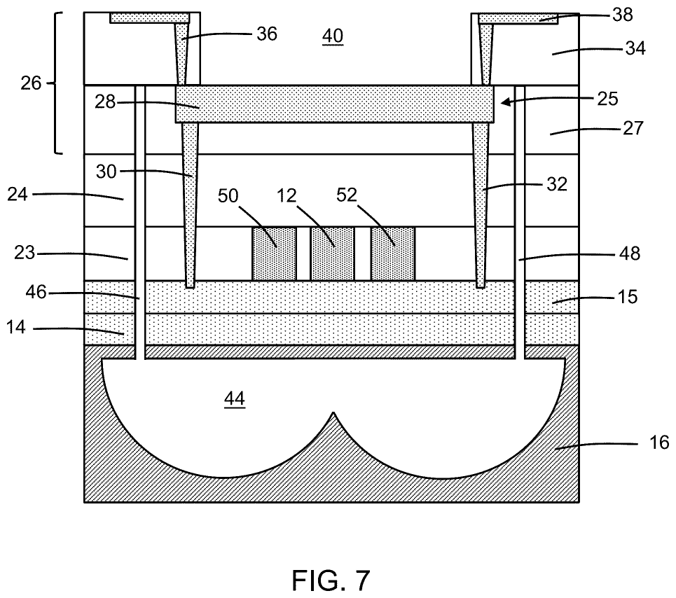

With reference to FIG. 7 in which like reference numerals refer to like features in FIG. 5 and in accordance with alternative embodiments, additional waveguide cores 52, 54 may be introduced adjacent to the waveguide core 12. In an embodiment, the heating element 28 may overlap with all the waveguide cores 12, 52, 54. The waveguide core 52 is laterally positioned between the waveguide core 12 and the extension 30, and the waveguide core 54 is laterally positioned between the waveguide core 12 and the extension 32.

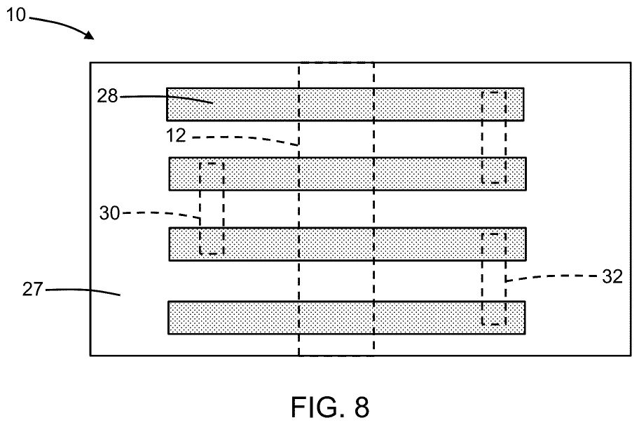

With reference to FIG. 8 in which like reference numerals refer to like features in FIG. 2 and in accordance with alternative embodiments, the heating element 28 of the heater 25 may be divided into multiple strips that are positioned over an adjacent portion of the waveguide core 12. The strips constituting the heating element 28 may extend across, and overlap with, an adjacent portion of the waveguide core 12. The strips constituting the heating element 28, which are spaced along the length of the waveguide core 12, are separated by gaps. The extensions 30, 32 may extend across the gaps between adjacent pairs of strips of the heating element 28 to provide electrical connections. For example, adjacent pairs of strips of the heating element 28 may be connected together in a daisy chain by bar vias embodied in the extensions 30, 32.

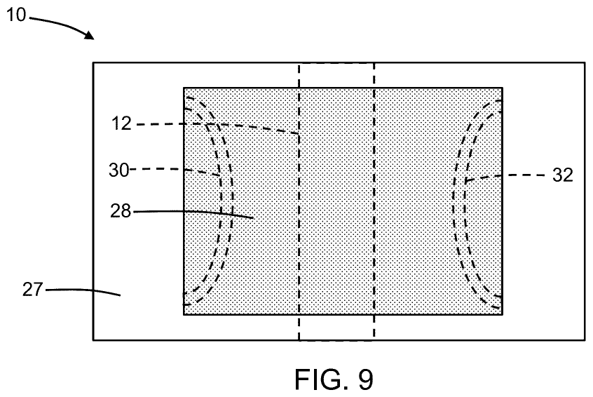

With reference to FIG. 9 in which like reference numerals refer to like features in FIG. 2 and in accordance with alternative embodiments, the extensions 30, 32 may be curved with respective concavities that are oriented to face away from the waveguide core 12. In an embodiment, the curved extensions 30, 32 may be curved bar vias.

The methods as described above are used in the fabrication of integrated circuit chips. The resulting integrated circuit chips can be distributed by the fabricator in raw wafer form (e.g., as a single wafer that has multiple unpackaged chips), as a bare die, or in a packaged form. The chip may be integrated with other chips, discrete circuit elements, and/or other signal processing devices as part of either an intermediate product or an end product. The end product can be any product that includes integrated circuit chips, such as computer products having a central processor or smartphones.

References herein to terms modified by language of approximation, such as “about”, “approximately”, and “substantially”, are not to be limited to the precise value or precise condition as specified. In embodiments, language of approximation may indicate a range of +/−10% of the stated value(s) or the stated condition(s).

References herein to terms such as “vertical”, “horizontal”, etc. are made by way of example, and not by way of limitation, to establish a frame of reference. The term “horizontal” as used herein is defined as a plane parallel to a conventional plane of a semiconductor substrate, regardless of its actual three-dimensional spatial orientation. The terms “vertical” and “normal” refer to a direction in the frame of reference perpendicular to the horizontal plane, as just defined. The term “lateral” refers to a direction in the frame of reference within the horizontal plane.

A feature “connected” or “coupled” to or with another feature may be directly connected or coupled to or with the other feature or, instead, one or more intervening features may be present. A feature may be “directly connected” or “directly coupled” to or with another feature if intervening features are absent. A feature may be “indirectly connected” or “indirectly coupled” to or with another feature if at least one intervening feature is present. A feature “on” or “contacting” another feature may be directly on or in direct contact with the other feature or, instead, one or more intervening features may be present. A feature may be “directly on” or in “direct contact” with another feature if intervening features are absent. A feature may be “indirectly on” or in “indirect contact” with another feature if at least one intervening feature is present. Different features may “overlap” if a feature extends over, and covers a part of, another feature.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A structure for a thermo-optic phase shifter, the structure comprising:
a first waveguide core; and
a heater that includes a first heating element, a first extension that projects from the first heating element, and a second extension that projects from the first heating element, the first heating element overlapping with a portion of the first waveguide core, and the portion of the first waveguide core laterally between the first extension and the second extension.

2. The structure of claim 1 wherein the first heating element, the first extension, and the second extension comprise a conductor.

3. The structure of claim 1 wherein the first heating element, the first extension, and the second extension comprise a metal.

4. The structure of claim 1 wherein the first extension is a first bar via, and the second extension is a second bar via.

5. The structure of claim 4 wherein the first bar via is curved with a first concavity that faces away from the first waveguide core, and the second bar via is curved with a second concavity that faces away from the first waveguide core.

6. The structure of claim 1 wherein the first waveguide core has a first side surface and a second side surface, the first side surface is positioned laterally between the second side surface and the first extension, and the second side surface is positioned laterally between the first side surface and the second extension.

7. The structure of claim 6 wherein the first waveguide core has an upper surface between the first side surface and the second side surface, and the upper surface is positioned adjacent to the first heating element.

8. The structure of claim 7 wherein the first heating element is a planar strip that extends parallel to the upper surface of the first waveguide core.

9. The structure of claim 1 further comprising:
a second waveguide core adjacent to the first waveguide core,
wherein the first heating element overlaps with a portion of the second waveguide core, and the portion of the second waveguide core is laterally between the first extension and the portion of the first waveguide core.

10. The structure of claim 1 wherein the first waveguide core comprises silicon nitride.

11. The structure of claim 1 wherein the first waveguide core comprises a dielectric material.

12. The structure of claim 1 further comprising:
a dielectric layer between the first waveguide core and the heater.

13. The structure of claim 1 further comprising:
one or more dielectric layers positioned between the first waveguide core and the first heating element,
wherein the first extension and the second extension are respective bar vias that are disposed in the one or more dielectric layers.

14. The structure of claim 13 further comprising:
a semiconductor substrate including a cavity beneath the first waveguide core,
wherein the one or more dielectric layers include a first trench and a second trench, the first extension is laterally positioned between the first trench and the first waveguide core, and the second extension is laterally positioned between the second trench and the first waveguide core.

15. The structure of claim 14 wherein the first waveguide core is positioned between the cavity and the first heating element.

16. The structure of claim 1 further comprising:
one or more dielectric layers including a recess,
wherein the first heating element is positioned between the first waveguide core and the recess.

17. The structure of claim 1 wherein the heater includes a second heating element, and the first waveguide core is vertically positioned between the first heating element and the second heating element.

18. The structure of claim 17 wherein the first extension is a first bar via that connects the first heating element to the second heating element, and the second extension is a second bar via that connects the first heating element to the second heating element.

19. The structure of claim 18 wherein the first waveguide core is fully surrounded by the first bar via, the second bar via, the first heating element, and the second heating element.

20. A method of forming a structure for a thermo-optic phase shifter, the method comprising:
forming a waveguide core; and
forming a heater that includes a heating element, a first extension that projects from the heating element, and a second extension that projects from the heating element,
wherein the heating element overlaps with a portion of the waveguide core, and the portion of the waveguide core is positioned laterally between the first extension and the second extension.
